(19) United States
(12) Patent Application Publication
(10) Pub. No.: US 2020/0331161 A1
(43) Pub. Date: Oct. 22, 2020

(54) WATERJET CUTTING SYSTEM

(71) Applicant: Gongin Precision Industries Co., Ltd., Kaohsiung City (TW)

(72) Inventors: Yo-Hsin SU, Kaohsiung City (TW); Pin-Tsung Cheng, Kaohsiung City (TW); Hung-Hsiang Lin, Kaohsiung City (TW)

(21) Appl. No.: 16/580,071

(22) Filed: Sep. 24, 2019

(30) Foreign Application Priority Data
Apr. 22, 2019 (TW) 108113976

(51) Int. Cl. B26D 5/00; B26F 3/00; B26D 5/06

(52) U.S. Cl. CPC B26D 5/007; B26D 5/06; B26F 3/004

(57) ABSTRACT

A waterjet cutting system (1) includes a controller (31) and a compensation module (23). The controller (31) is configured to control a motor (23) to move a waterjet cutting head (22) to a predetermined angle (θ₁). The compensation module (32) is configured to calculate a compensation angle (ε) based upon the predetermined angle (θ₁), a rotating angle (θ₂) of the motor, and an inclination angle (θ₃) of the waterjet cutting head (22) detected by an IMU (25) mounted on the waterjet cutting head (22). The controller (31) is further configured to implement angular compensation for the waterjet cutting head (22) by controlling the motor (23) to move the waterjet cutting head (22) by the compensation angle (ε).

### CROSS-REFERENCE TO RELATED APPLICATION

This application claims priority of Taiwanese Patent Application No. 108113976, filed on Apr. 22, 2019.

### FIELD

The disclosure relates to a waterjet cutting system, and more particularly to a waterjet cutting system that includes a compensation module for calculating a compensation angle.

### BACKGROUND

A conventional 5-axis waterjet cutting machine is used to cut a workpiece with a high-pressure jet of water, or a mixture of water and an abrasive. The axes of the conventional 5-axis waterjet cutting machine are normally named Y-axis (back/forth), X-axis (left/right), Z-axis (up/down), A-axis (angle from perpendicular) and C-axis (rotation around the Z-axis). A cutting head of the conventional 5-axis waterjet cutting machine can be controlled to move linearly along the X-axis, the Y-axis and the Z-axis, and to rotate around the X-axis and the Z-axis.

A number of motion control systems were developed to position a nozzle (or cutting head) of a waterjet cutting machine.

U.S. Patent Application Publication No. 2018/0364679 A1 provides a motion control system adopting a mathematical model to optimize operating parameters of a waterjet cutting machine. The mathematical model compares various cutting parameters applied to the same cutting path, and then determines optimized parameter settings to improve machining accuracy of the waterjet cutting machine.

U.S. Patent Application Publication No. 2018/0059638 A1 provides a fluid jet cutting system including a control unit configured to control motion of a fluid jet cutting head of the fluid jet cutting system relative a workpiece to be cut. The control unit is coupled to a fluid jet cutting head drive configured to incline the fluid jet cutting head relative a vertical line. The control unit is configured to automatically adapt the speed of the fluid jet cutting head in accordance with a predetermined inclination angle value for reaching a desired quality of the cut surface.

U.S. Pat. No. 9,597,772 B2 provides exemplary embodiments of an Adaptive Vector Control System (AVCS) for determining deviation correction angles, and for generating motion instructions that indicate desired movement of a fluid jet cutting head. The AVCS uses a received geometry specification (i.e., a design for a target piece) to calculate an offset geometry, and then to segment the offset geometry into a number of part geometry vectors (PGVs). The AVCS further determines the tilt of the fluid jet cutting head by mathematical predictive models with the PGVs.

However, in a conventional waterjet cutting machine, an inclination angle of a cutting head may deviate from a desired angle during a cutting operation because of particles of the abrasive, materials of machining parts and work pieces, the pressure in a nozzle of the cutting head, or the pitch error of the machine, etc. As a result, the conventional waterjet cutting machine cannot maintain its machining accuracy. Building mathematical models or adapting the speed of the cutting head may not correct the inclination angel timely and accurately.

### SUMMARY

Therefore, an object of the disclosure is to provide a waterjet cutting system that can alleviate at least one of the drawbacks of the prior art.

According to one aspect of the disclosure, a waterjet cutting system that calculates and implements angular compensation for a waterjet cutting head based on an inclination angle detected by an inertial measurement unit (IMU) is provided.

The waterjet cutting system includes a waterjet cutting device, a controller, and a compensation module.

The waterjet cutting device includes a supporting arm, a waterjet cutting head mounted on the supporting arm, a motor connected to the supporting arm, and the IMU. The motor is configured to move the supporting arm together with the waterjet cutting head. The IMU is mounted on the waterjet cutting head for detecting an inclination angle of the waterjet cutting head.

The controller is electrically connected to the motor, and is configured to control the motor to move the waterjet cutting head to a predetermined angle.

The compensation module is electrically connected to the controller, and is electrically connected to the waterjet cutting device for receiving the inclination angle of the waterjet cutting head and a rotating angle. The motor rotates by the rotating angle in response to control of the controller to move the waterjet cutting head. The compensation module is configured to calculate a compensation angle based upon the predetermined angle, the rotating angle and the inclination angle, and to transmit the compensation angle to the controller.

The controller is further configured to implement angular compensation for the waterjet cutting head by controlling the motor to move the waterjet cutting head by the compensation angle upon receiving the compensation angle.

### BRIEF DESCRIPTION OF THE DRAWINGS

Other features and advantages of the disclosure will become apparent in the following detailed description of the embodiment (s) with reference to the accompanying drawings, of which:

FIG. 1 is a block diagram exemplarily illustrating components of a waterjet cutting system according to an embodiment of this disclosure;

FIG. 2 is a schematic view exemplarily illustrating a waterjet cutting device of the waterjet cutting system;

FIG. 3 is a block diagram schematically illustrating the waterjet cutting system for computing a compensation angle according to one embodiment of this disclosure; and

FIG. 4 schematically illustrates computation of the compensation angle.

### DETAILED DESCRIPTION

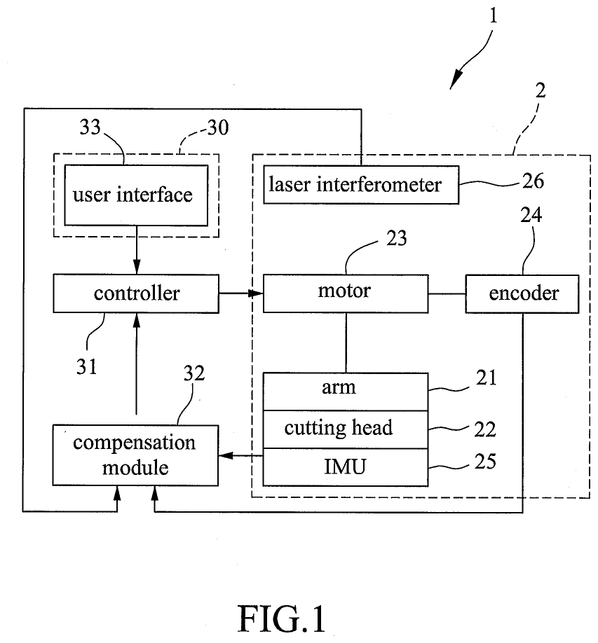

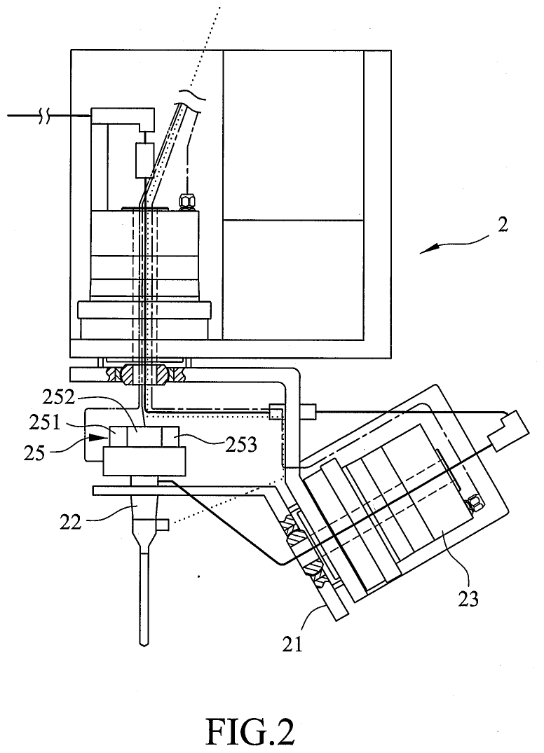

Referring to FIGS. 1 and 2, a waterjet cutting system 1 according to an embodiment of the present disclosure includes a five-axis waterjet cutting device 2, a controller 31 that is configured to control the waterjet cutting device 2, and a compensation module 32 that is configured to calculate a compensation angle for angular compensation. The waterjet cutting device 2 may be a CNC machine, while the controller 31 may be a CNC controller for controlling the CNC machine via specific input instructions, such as G-code or M-code.

The waterjet cutting device 2 includes a supporting arm 21, a waterjet cutting head 22 mounted on the supporting arm 21, a motor 23 configured to move the supporting arm 21 together with the waterjet cutting head 22, a rotary encoder 24 configured to monitor operation of the motor 23, an inertial measurement unit (IMU) 25 to detect an actual angular displacement of the waterjet cutting head 22, and a laser interferometer 26 to detect geometric errors of the waterjet cutting device 2 due to limited accuracy of individual machine components of the waterjet cutting device 2.

The waterjet cutting head 22 may consist of a pressure valve (not shown), an orifice (not shown), a mixing chamber (not shown) and a nozzle (not shown), etc., and is used for processing a workpiece (not shown).

The motor 23 is connected to the supporting arm 21 to move the supporting arm 21 together with the waterjet cutting head 22 along five axes, namely Y-axis, X-axis, Z-axis, A-axis (angle from perpendicular), and C-axis (rotation around the Z-axis). The waterjet cutting head 22 can move linearly along the X-axis, the Y-axis and the Z-axis, and rotate around the X-axis and the Z-axis. The rotary encoder 24 is mounted on the motor 23 to detect angular positions and/or motion of a shaft of the motor 23.

The IMU 25 is directly mounted on the waterjet cutting head 22, and includes a gyroscope 251, an accelerometer 252 and a magnetometer 253. The IMU 25 detects an actual angular inclination of the waterjet cutting head 22 with respect to a tool center point (TCP) of the waterjet cutting head 22.

The laser interferometer 26 is disposed, but not limited to, near the waterjet cutting head 22 for detecting the geometric errors, including pitch error and backlash, etc., of the waterjet cutting device 2.

The controller 31 is electrically connected to the motor 23, and the the compensation module 32 is electrically connected to the controller 31 and the rotary encoder 24, the IMU 25 and the laser interferometer 26 of the waterjet cutting device 2.

It should be noted that a number of the supporting arm 21, a number of the motor 23 and a number of the rotary encoder 24 in the present disclosure are each not limited to “one.” According to some embodiments, the waterjet cutting device 2 may include a plurality of supporting arms 21 linked together, a plurality of motors 23 connected respectively to the supporting arms 21, and a plurality of rotary encoders 24 mounted respectively on the motors 23. In this case, the waterjet cutting head 22 is mounted on a distal end of the supporting arms 21, and the motors 23 operate collaboratively to move the supporting arms 21 together with the waterjet cutting head 22 along the five axes.

In this embodiment, the waterjet cutting system 1 further includes a computer device 30 that includes a user interface 33 allowing an operator to input operation parameters, such as a processing angle θ₁₁, desired surface quality, pressure of waterjet, diameter of the orifice of the waterjet cutting head 22, material of the workpiece, thickness of the workpiece, type of abrasive, grain size of abrasive, flow rate of abrasive, etc. The processing angle θ₁₁ is a cutting angle of the waterjet cutting head 22, for example, measured from the A-axis with respect to the TCP, and is actually desired for the waterjet cutting head 22 to process on the workpiece. The controller 31 is further connected to the computer device 30 for obtaining the operation parameters, and is configured to execute preliminary calculations to obtain setting values (such as standoff distance, attack angle, moving speed of the waterjet cutting head 22, cutting time, and an adjustment value (θ₁₂), etc.) based on the operation parameters. For example, the preliminary calculations include big data management and analysis. In other embodiments, the preliminary calculations may include searching the setting values from lookup tables. In some embodiments, the adjustment value θ₁₂ can be determined through experimentation or based on the operation parameters.

In some embodiments, the user interface 33 is integrated into the controller 31. In further embodiments, the compensation module 32 is integrated into the controller 31 as well. In other embodiments, the compensation module 32 is integrated into the computer device 30.

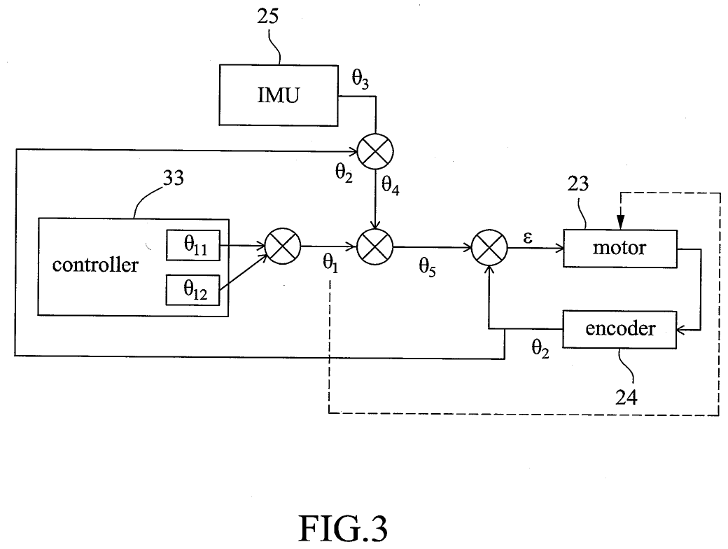

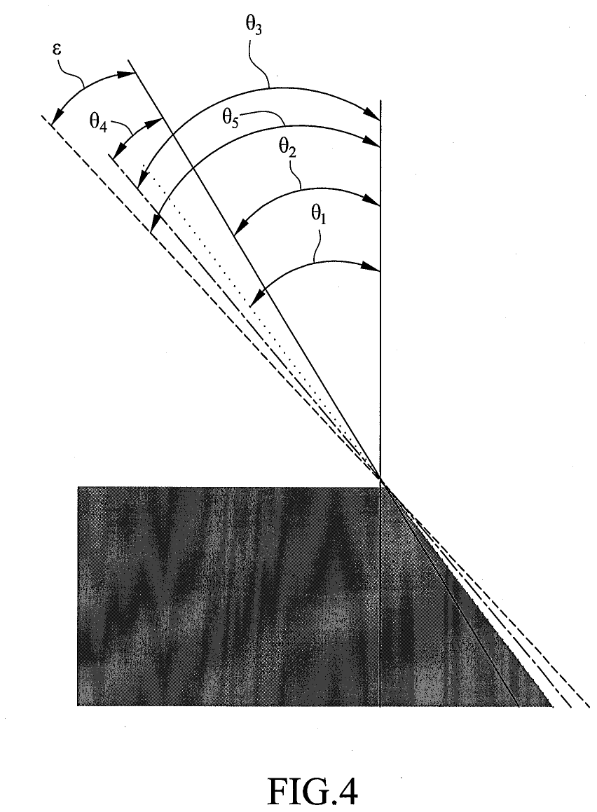

The compensation module 32 may be embodied using a set of software/firmware instructions that is stored in a storage module (not shown) and that may be executed by a processor. The processor may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc. The storage module may be embodied using one or more of a hard disk, a solid-state drive (SSD), flash memory or other non-transitory storage medium. Referring to FIGS. 3 and 4, a process of implementing the angular compensation for the waterjet cutting head 22 according to this embodiment is implemented by the waterjet cutting system 1 of FIG. 1 as detailed below.

First, the controller 31 receives the operation parameters inputted via the user interface 33. The controller 31 then executes the preliminary calculations to obtain the setting values based on the operation parameters. For example, the controller 31 receives the processing angle θ₁₁=6°, and obtains the adjustment value θ₁₂=0.01° which is determined by big data analysis or by looking up a lookup table and is used to adjust the processing angle. The lookup table may be pre-established based on experience or by experiment. It is also noted that, in some embodiments, the adjustment value θ₁₂ may be modified manually via the user interface 33. The controller 31 then adds up the processing angle θ₁₁ and the adjustment value θ₁₂ to obtain a sum which serves as a predetermined angle θ₁=6.01°. The waterjet cutting device 2 loads the setting values and the predetermined angle θ₁ to execute a preliminary process accordingly.

In the preliminary process, the controller 31 controls the motor 23 to move the supporting arm 21 together with the waterjet cutting head 22 according to the setting values and the predetermined angle θ₁. After the motor 23 moves the supporting arm 21, the rotary encoder 24 detects the\angular position of the motor 23, converts the detected angular position to a value, i.e., a rotating angle θ₂, and then outputs the rotating angle θ₂ to the compensation module 32. For example, the rotating angle θ₂ is equal to 6°.

When the waterjet cutting head 22 is moved with the supporting arm 21, the IMU 25 directly mounted on the waterjet cutting head 22 can detect an actual angle of the waterjet cutting head 22 with respect to the TCP, i.e., an inclination angle θ₃. For example, the inclination angle θ₃ is equal to 6.05°.

Ideally, the inclination angle θ₃ detected by the IMU 25, the rotating angle θ₂ detected by the rotary encoder 24 and the predetermined angle θ₁ should be equal to one another. However, there may be inconsistency among these angles due to mechanical tolerances and actual processing conditions, etc. The compensation module 32 according to one embodiment of the present disclosure is then used for alleviating the inconsistency.

The compensation module 32 receives the inclination angle θ₃ from the IMU 25 and the rotating angle θ₂ from the rotary encoder 24, and calculates a deviation angle θ₄ which is a difference between the inclination angle θ₃ and the rotating angle θ₂. In this example, the deviation angle θ₄ is equal to 0.05° (i.e., θ₄=θ₃−θ₂).

The compensation module 32 further adds up the deviation angle θ₄ and the predetermined angle θ₁ to obtain a sum which serves as a command angle θ₅ (i.e., θ₅=θ₁+θ₄=6.01°+0.05°=6.06°), and subtracts the rotating angle θ₂ from the command angle θ₅ to obtain a difference which serves as a compensation angle ε (i.e., ε=θ₅−θ₂=6.06°−6°=0.06°).

Then, the controller 31 receives the compensation angle ε, and controls the motor 23 to implement angular compensation. In the angular compensation, the controller 31 controls the motor 23 to move the waterjet cutting head 22 again by the compensation angle ε. Ideally, after the angular compensation, the waterjet cutting head 22 can be positioned at an angle, as detected by the IMU 25, that may just equal to the processing angle θ₁₁.

In some embodiments, the compensation module 32 is further configured to calculate a displacement compensation value based upon the pitch error detected by the laser interferometer 26, and the controller 31 is further configured to implement displacement compensation for the waterjet cutting head 22 by controlling the motor 23 to linearly move the waterjet cutting head 22 according to the displacement compensation value.

In sum, during operation, it is possible that the waterjet cutting head 22 is not moved to a desired angular position because of mechanical tolerances or processing conditions. By implementing the angular compensation for the waterjet cutting head 22, the angular position of the waterjet cutting head 22 can be adjusted, and thus an error in angular position (i.e., a difference between an actual angular position of the waterjet cutting head 22 and the desired angular position of the waterjet cutting head 22) can be alleviated.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A waterjet cutting system, comprising:
a waterjet cutting device including
a supporting arm,
a waterjet cutting head mounted on said supporting arm,
a motor connected to said supporting arm and configured to move said supporting arm together with said waterjet cutting head, and
an inertial measurement unit (IMU) mounted on said waterjet cutting head for detecting an inclination angle of said waterjet cutting head;
a controller electrically connected to said motor, and configured to control said motor to move said waterjet cutting head to a predetermined angle; and
a compensation module electrically connected to said controller, and electrically connected to said waterjet cutting device for receiving the inclination angle of said waterjet cutting head and a rotating angle by which said motor rotates in response to control by said controller to move said waterjet cutting head,
wherein said compensation module is configured to calculate a compensation angle based upon the predetermined angle, the rotating angle and the inclination angle, and to transmit the compensation angle to said controller, and
wherein said controller is further configured to implement angular compensation for said waterjet cutting head by controlling said motor to move said waterjet cutting head by the compensation angle upon receiving the compensation angle.

2. The waterjet cutting system as claimed in claim 1, wherein said compensation module is configured to calculate the compensation angle by:
calculating a deviation angle which is a difference between the rotating angle of said motor and the inclination angle detected by said IMU;
adding up the deviation angle and the predetermined angle to obtain a sum to serve as a command angle; and
subtracting the rotating angle from the command angle to obtain a difference to serve as the compensation angle.

3. The waterjet cutting system as claimed in claim 2, wherein said controller is configured to obtain the predetermined angle by adding up a processing angle and an adjustment value to obtain a sum that serves as the predetermined angle, and
wherein the processing angle is one of operation parameters inputted via a user interface, and the adjustment value is one of setting values obtained based on the operation parameters.

4. The waterjet cutting system as claimed in claim 1, wherein said controller is further connected to a computer device for obtaining, via a user interface of said computer device, operation parameters, including at least one of processing angle, desired surface quality, pressure of waterjet, diameter of an orifice of said waterjet cutting head, material of workpiece, thickness of workpiece, type of abrasive, grain size of abrasive or flow rate of abrasive.

5. The waterjet cutting system as claimed in claim 4, wherein said controller is configured to execute preliminary calculations to obtain setting values, including standoff distance, attack angle, moving speed of said waterjet cutting head, cutting time, and adjustment value, based on the operation parameters.

6. The waterjet cutting system as claimed in claim 5, wherein the preliminary calculations include at least one of: big data management and analysis, or searching the setting values from lookup tables.

7. The waterjet cutting system as claimed in claim 1, wherein said waterjet cutting device further includes a rotary encoder mounted on said motor to detect and output the rotating angle.

8. The waterjet cutting system as claimed in claim 1, wherein said IMU includes a gyroscope, an accelerometer and a magnetometer to detect the inclination angle of said waterjet cutting head with respect to a tool center point.

9. The waterjet cutting system as claimed in claim 1, wherein said waterjet cutting device further includes a laser interferometer for detecting a pitch error of said waterjet cutting device.

10. The waterjet cutting system as claimed in claim 9, wherein said compensation module is further configured to calculate a displacement compensation value based upon the pitch error, and said controller is further configured to implement displacement compensation for said waterjet cutting head by controlling said motor to move said waterjet cutting head according to the displacement compensation value.
